(19) United States
(12) Patent Application Publication
(10) Pub. No.: US 2009/0308229 A1
(43) Pub. Date: Dec. 17, 2009

(54) DECODING SOUND PARAMETERS

(75) Inventors: Marek Zbigniew Szczerba, Eindhoven (NL); Andreas Johannes Gerrits, Oeffelt (NL); Marc Klein Middelink, Huissen (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/306,605

(22) PCT Filed: Jun. 27, 2007
(86) PCT No.: PCT/IB07/52488

§ 371 Date: Dec. 24, 2008

(30) Foreign Application Priority Data
Jun. 29, 2006 (EP) 06116297.0
Jun. 27, 2007 (IB) PCT/IB2007/052488

(51) Int. Cl. G10H 7/00

(52) U.S. Cl. 84/622

(57) ABSTRACT

A device (1) for producing sound samples from sound parameters representing sound components comprises a transient synthesis unit (14) for synthesizing transient sound components from transient sound parameters contained in each frame. To increase the efficiency of the synthesis, a transient selection unit (11) is arranged for selecting only a single transient sound component per frame. Additionally, the device may be arranged for producing fewer sinusoidal sound components if a transient is produced. Transform domain coefficients may be convolved with a transform domain representation of a time window representation, the number of resulting transform domain coefficients being controlled to further enhance the efficiency of the synthesis.

### FIELD OF THE INVENTION

The present invention relates to decoding sound parameters and synthesizing sound. More in particular, the present invention relates to a device for and a method of producing sound samples from sound parameters representing transient sound components, sinusoidal sound components and/or other sound components.

### BACKGROUND OF THE INVENTION

It is well known to produce sound samples from sound parameters, such as temporal and/or spectral envelope parameters, spectral coefficients, and other parameters. Parametric decoders, for example, are capable of decoding such parameters and producing sound samples which can subsequently be converted into an analog sound signal. Parametric synthesizers likewise use sound parameters to produce sound samples.

The sound parameters and the resulting sound samples are typically arranged in frames: sets of data that may be processed in a single routine. Each frame may contain one or more parameters, which may be processed to produce a number of sound samples. As the number of sound samples may be much greater than the number of parameters from which they are derived, the parameters typically constitute an efficient representation of the sound.

Different types of sound parameters may be used to represent different components of the sound. For example, some sound parameters may represent only transient sound components, while other sound parameters may represent other sound components, for example sinusoidal components and/or noise components. As these sound components have different properties, they can be represented more efficiently by different sets of parameters.

The number of sound components per frame may be very large. However, synthesizing many sound components may require a large number of computations. This requires a device having a relatively large processing power, which is not feasible in many applications.

### SUMMARY OF THE INVENTION

It is an object of the present invention to overcome these and other problems of the Prior Art and to provide a device for and method of producing sound samples from sound parameters which involve fewer computations.

Accordingly, the present invention provides a device for producing sound samples from sound parameters representing transient sound components and other sound components, the device comprising means for reducing the number of sound parameters to be synthesized.

More in particular, the present invention provides a device for producing sound samples from sound parameters representing sound components, the device comprising:
at least one selection unit for receiving frames containing sound parameters which represent sound components and for selecting, for each frame, a limited number of sound components, and
at least one synthesis unit for synthesizing selected sound components from their parameters.

The selection unit may be a transient selection unit for selecting a single transient sound component per frame, and the synthesis unit may be a transient synthesis unit for synthesizing any selected transient components.

By selecting only a single transient sound component in each frame containing transient sound components, the synthesis of multiple transient (sound) components per frame is avoided. It has been found that the synthesis of multiple transient components is computationally very demanding, and that the processing required can be significantly reduced by synthesizing only one transient component per frame. It has further been found that the quality of the sound is in most cases hardly affected. Thus the efficiency of the sound production is greatly improved while the omission of the further transients of each frame is hardly audible.

It will be understood that some frames may contain no transient sound components, in which case no transient component will be synthesized. Other frames may contain only a single transient component, which will accordingly be selected.

The transient selection unit may select the single transient to be synthesized in various ways. It is possible to select the first transient of each frame and ignore the (parameters of the) remaining ones. However, other criteria can be used to select a transient sound component. In a preferred embodiment, the selection unit is provided with means for selecting the transient sound component having the largest energy content.

Sound components of a particular frame, and in particular transients, may extend into the next frame. When synthesizing the sound of a frame, it is possible that part of the sound of the previous frame is also being synthesized. In such cases, it is still possible for two (or possibly even more than two) transient sound components to be synthesized simultaneously, even when the present invention is utilized. To further increase the efficiency of the synthesis, the transient synthesis unit is preferably provided with a discontinuation unit for discontinuing a transient sound component of a previous frame when synthesizing a transient sound component in the present frame.

The device of the present invention may additionally, or alternatively, comprise a sinusoid selection unit for selecting one or more sinusoidal sound components for each frame containing sinusoidal sound components, and a sinusoid synthesis unit for synthesizing selected sinusoidal sound components from their parameters.

If the device also comprises a transient synthesis unit, the sinusoid selection unit may advantageously be dependent on the transient selection unit and may produce fewer sinusoidal sound components if the transient selection unit selects a transient for the same frame. Accordingly, the sinusoid selection unit is preferably controlled by the transient selection unit, the number of selected sinusoidal components depending on the presence of a transient component in the same frame.

In an embodiment comprising a sinusoid selection unit, reducing the number of sinusoids if a transient is being synthesized reduces the required number of computations. It has been found that this measure hardly affects the sound quality, as the transient “masks” the sinusoids. In frames containing no transients, all sinusoidal sound components may be selected and synthesized.

It is noted that the feature of producing fewer sinusoidal sound components if the transient synthesis unit produces a transient for the same frame can be used independently, and can therefore also be used in devices that synthesize more than one transient per frame.

If a particular frame contains no transients but the previous frame did, a transient may still be synthesized. In such cases, the number of sinusoids may also be reduced to reduce the computational load. The selection of sinusoidal components and transient components is preferably based on their psycho-acoustical relevance, while the sinusoid selection and the transient selection may mutually influence each other.

As the synthesis of sinusoids in a transform domain is generally more efficient than in the time domain, it is preferred that the sinusoidal sound parameters represent transform domain coefficients, or represent data that can be converted into transform domain coefficients. In addition, the device preferably further comprises an inverse transform unit for transforming transform domain coefficients into time domain samples. The transform domain preferably is the frequency domain, in particular the complex spectrum domain, the inverse transform being an inverse fast Fourier transform (IFFT). However, other transform domains and associated (inverse) transforms may be used, for example the (discrete) cosine transform domain or the quadrature mirror filter (QMF) transform domain.

It is noted that the sound parameters may be transform domain coefficients, such as Fourier coefficients, but that it may also be possible to generate transform domain coefficients from the sound parameters. In the former case the sound parameters are equal to transform domain coefficients, while in the latter case the sound parameters represent such coefficients or equivalent data and may be converted into transform domain sound coefficients.

In a preferred embodiment, the sinusoidal synthesis unit comprises a convolution unit for convolving the transform domain sound coefficients with a transform domain representation of a time window, and a coefficient limiting unit for limiting the number of additional transform domain sound coefficients resulting from the convolution. The coefficient limiting unit may effectively limit the number of sound coefficients after convolution by selecting a sub-set of the available set of coefficients.

It is advantageous to process the sound coefficients using a representation of a time window so as to produce sound data (coefficients or samples) corresponding with a suitable time duration. The processing may involve multiplication when the sound parameters represent time domain coefficients, or convolution when the sound parameters represent transform domain coefficients. A convolution typically causes an increase in the number of non-zero transform domain coefficients. This, however, also increases the amount of processing required.

According to a further aspect of the present invention, the coefficient limiting unit may be arranged for limiting the number of transform domain coefficients in a frame in dependence of the original number of sound parameters in the frame. For example, the number of selected additional coefficients may be small if the original number of coefficients is large. In this way, the total number of coefficients may be kept approximately constant, or at least below a certain maximum. Alternatively, the number of additional coefficients may be kept approximately constant or below a certain maximum.

The number of additional coefficients may be limited in various ways. In a particularly advantageous embodiment, the number of additional coefficients in a frame is equal to:
six if the original number of coefficients is smaller than three,
four if the original number of coefficients is between three and five,
two if the original number of coefficients is greater than four.

It will be understood, however, that these numbers may depend on the particular frame length and other considerations, such as the energy of the respective sinusoidal components, and will generally depend on the particular embodiment. In particular, the numbers stated above may apply per frequency band, preferably per ERB band or similar band, as the well-known ERB (Equivalent Rectangular Bandwidth) scale takes psycho-acoustic considerations into account.

The device of the present invention may comprise a noise selection unit for selecting, for each frame, noise sound components to be synthesized, and a noise synthesis unit for synthesizing selected noise sound components from their parameters. By selecting noise components prior to the synthesis, the computational load can be further reduced. The selection of noise components may be independent or may depend on the selection of transient and/or sinusoidal components.

The device of the present invention may further comprise an output unit for outputting the sound samples, the output unit preferably being provided with means for adding overlapping frames. That is, the output unit may use the well-known overlap-and-add technique to combine the frames into an output signal.

Additionally, or alternatively, the device of the present invention may comprise a frame forming unit for forming frames containing sound parameters, in which case the transient selection unit, the sinusoid selection unit and/or the noise selection unit receives the frames from the frame forming unit.

The present invention further provides a consumer device comprising a device as defined above, as well as a sound system comprising a device as defined above. The consumer device of the present invention may be a portable consumer device, such as a mobile (US: cellular) telephone apparatus, a solid state music player, such as an MP3 player, a music synthesizer, or any other suitable device.

The present invention also provides a method of producing sound samples from sound parameters representing transient sound components and other sound components, the method comprising the steps of:
receiving frames containing sound parameters which represent sound components,
selecting, for each frame, a limited number of sound components, and
synthesizing any selected sound components from their parameters.

The method of the present invention has the same advantages as the device discussed above.

The selected sound components may comprise only a single transient component per frame. The method of the present invention may further comprise the step of synthesizing sinusoidal sound components from sinusoidal sound parameters contained in a frame, and producing fewer sinusoidal sound components if at least one transient sound component for the same frame is produced.

The sound parameters may represent transform domain parameters or data that can be converted into transform domain parameters, the method preferably further comprising the step of inversely transforming parameters.

Advantageously, the method of the present invention may comprise the step of convolving the transform domain sound coefficients with a transform domain representation of a time window, and limiting the number of additional sound coefficients resulting from the convolution.

The method of the present invention may also comprise the step of forming frames containing sound parameters which represent one or more sound components.

Further method steps according to the present invention will become apparent from the detailed description of the invention below.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

### BRIEF DESCRIPTION OF THE DRAWINGS

The present invention will further be explained below with reference to exemplary embodiments illustrated in the accompanying drawings, in which:

FIG. 1 schematically shows an exemplary embodiment of a device according to the present invention.

FIG. 2 schematically shows the process of limiting the number of parameters after convolution in accordance with the present invention.

FIG. 3 schematically shows limiting the duration of transient sound components of adjacent frames in accordance with the present invention.

FIG. 4 schematically shows a transients synthesis unit according to the present invention.

FIG. 5 schematically shows a sinusoid synthesis unit according to the present invention.

FIG. 6 schematically shows a consumer device according to the present invention.

### DETAILED DESCRIPTION OF PREFERRED EMBODIMENTS

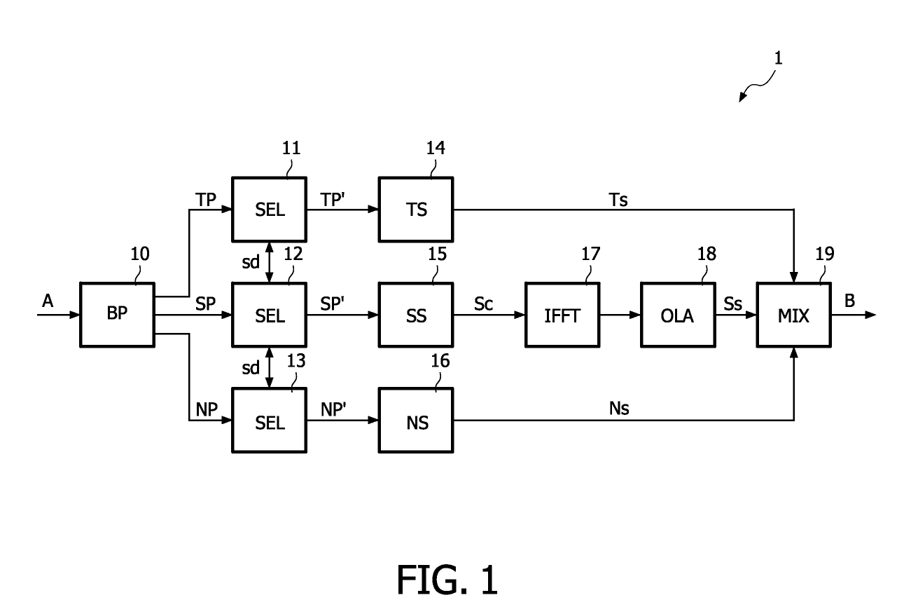

The inventive device 1 shown merely by way of non-limiting example in FIG. 1 comprises a bitstream parser (BP) unit 10, a transient selection (SEL) unit 11, a transients synthesis (TS) unit 14, a sinusoid selection (SEL) unit 12, a sinusoid synthesis (SS) unit 15, a noise selection (SEL) unit 13, a noise synthesis (NS) unit 15, a spectrum building (SB) unit 16, an inverse fast Fourier transform (IFFT) unit 17, an overlap-and-add (OLA) unit 18, and a mixing (MIX) and output unit 19.

In the embodiment shown, the device 1 receives an input bitstream A which comprises sound parameters, and produces an output signal B which comprises time domain sound samples.

The bitstream parser 10 parses the input bitstream A and forms frames containing sound parameters. The frames may contain transient parameters (TP), sinusoidal parameters (SS) and/or noise parameters (NP) representing transient, sinusoidal and noise sound components respectively. The parameters of each frame are supplied to the transients synthesis unit 13, the sinusoidal synthesis unit 14 and the noise synthesis unit 15 respectively. It is noted that in some embodiments only one or two types of sound parameters may be distinguished, while in other embodiments three, four or more different types of sound parameters may be used. The bitstream parser 10 may have multiple input terminals to receive multiple channels (for example multiple instruments in a synthesizer).

According to the present invention, the transient parameters TP are not fed directly to the transients synthesis unit 14. Instead, the transient parameters TP are first supplied to the transient selection unit 11 which selects one transient out of the transients present in the particular frame (it is noted that in alternative embodiments more than a single transient per frame may be selected, for example two transients, while still obtaining at least part of the advantages of the present invention). The selection unit 11 selects a single transient, for example the transient having the largest energy content, and outputs the parameters TP′ of the selected transient. The selection data sd, which indicate whether a transient was selected, are sent to the sinusoid selection unit 12.

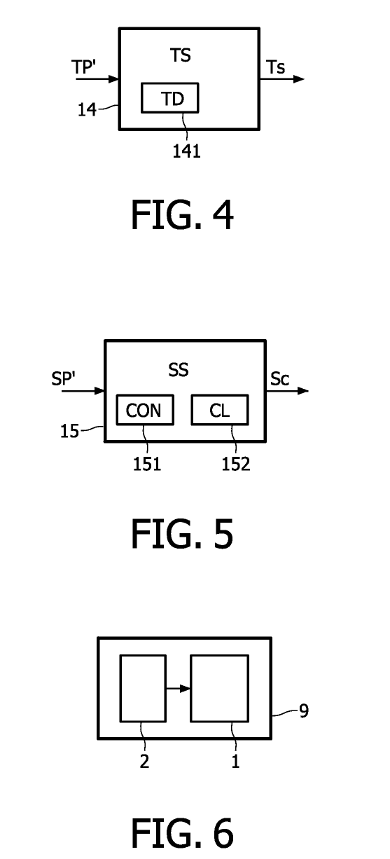

In the embodiment of FIG. 1 the transient selection unit 11 is shown as a separate unit. However, the transient selection unit 11 may alternatively be incorporated in the transients synthesis unit 14. The transient selection unit 11 will later be explained in more detail with reference to FIG. 4.

The transients synthesis unit 14 synthesizes transient (sound) components TC using the selected transient parameters TP′ and feeds the resulting samples Ts of this transient component to the mixing and output unit 19.

The sinusoid selection unit 12 receives the sinusoidal parameters SP and selects the parameters of one or more sinusoidal sound components. In the embodiment shown, this selection depends on the selection data sd received from the transient selection unit 11. If no transient is selected (typically, this means that no transient, or no transient having a significant amplitude is present in the current frame), the number of sinusoids can be relatively large, and all sinusoidal components of the current frame may be selected, for example. If a transient is selected, as indicated by the selection data sd, the number of sinusoids may be reduced, as effected by the sinusoid selection unit 12. If only a relatively small transient is present in the frame, it may be omitted in favor of relatively large sinusoids, in dependence on control data sd sent from the sinusoid selection unit 12 to the transient selection unit 11. A preferred embodiment of the sinusoid selection unit 12 will later be explained in more detail with reference to FIG. 5.

The sinusoid synthesis unit 14 synthesizes the selected sinusoidal (sound) components using the selected sinusoidal parameters SP′ and produces sinusoidal sound coefficients Sc, which in the present embodiment are spectral (that is, Fourier) coefficients. The coefficients Sc are inversely transformed by the inverse FFT (IFFT) unit 17. The resulting time domain samples are combined in the overlap-and-add (OLA) unit 18 to produce sinusoidal sound samples Ss, which are fed to the mixing and output unit 19.

The noise selection unit 13 similarly receives the noise parameters NP and selects the parameters of one or more noise sound components. In the embodiment shown, this selection depends on the selection data sd received from the transient selection unit 11 and the sinusoid selection unit 12. If no transient is selected (typically, this means that no transient, or no transient having a significant amplitude is present in the current frame), the number of noise components can be relatively large, and all noise components of the current frame may be selected, for example. If a transient is selected, as indicated by the selection data sd, the number of noise components may be reduced, also because the sinusoidal components will typically have less psycho-acoustic relevance. If a relatively large number of sinusoidal components is selected, as shown by the selection data sd received from the sinusoid selection unit 12, the number of noise components to be synthesized may be reduced.

The selection data sd may also be transferred in the opposite direction, for example reducing the number of transients if a certain number of sinusoids is synthesized, or suppressing a transient having a relatively low energy if the same frame contains sinusoids having a relatively high energy.

The noise synthesis unit 16 synthesizes noise (sound) components using the selected noise parameters NP′, and also feed the noise sound samples Ns of the synthesized components to the mixing and output unit 19, where they are combined with the transients sound samples Ts and the sinusoidal sound samples Ss to produce the output signal B.

The sinusoid selection unit 12 and the noise selection unit 13 are shown to be separate units. In alternative embodiments, the sinusoid selection unit 12 and/or the noise selection unit 13 may be incorporated in the sinusoid synthesis unit 14 and/or the noise synthesis unit 16 respectively. Similarly, the inverse transform unit 17 and the overlap-and-add unit 18 could be incorporated into the sinusoid synthesis unit 15 to form a single, combined unit.

In the exemplary embodiment of FIG. 1, the sinusoid synthesis unit 15 comprises a convolution unit which performs a convolution of the spectral (or other transform domain) coefficients represented by the selected sinusoidal parameters SP′ and a spectral (or other transform domain) representation of a suitable time window. The result of this convolution is a frame of spectral coefficients (in general: transform domain data), the length of the frame corresponding with a suitable transform length, for example 256 or 512 coefficients.

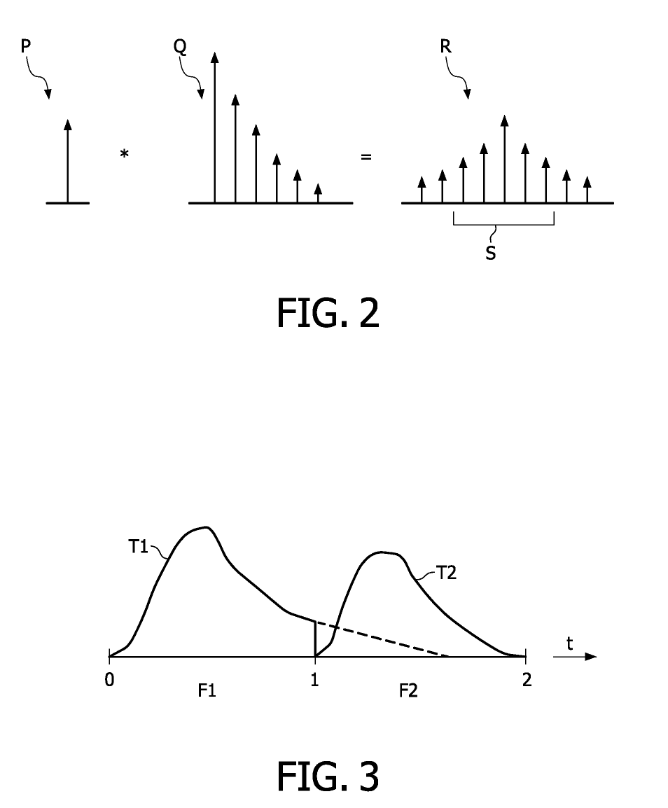

The convolution performed by the convolution unit (151 in FIG. 5) is schematically illustrated in FIG. 2, where an exemplary transform domain representation P has a single coefficient, which may for example represent a sinusoidal component. This transform domain representation P is convolved with the transform domain representation Q of a time window, the symbol “*” denoting convolution (in FIG. 2 only the absolute values of representations P and Q are shown for the sake of clarity). In the present example, the resulting transform domain representation R has nine coefficients, eight more than the original representation P.

Although the total number of transform domain coefficients may not be altered, the convolution typically results in an increased number of non-zero coefficients, which may be referred to as additional transform domain coefficients. According to a further aspect of the present invention, this number of additional transform domain coefficients (typically spectral bins) is limited by a coefficient limiting (CL) unit (152 in FIG. 5).

The additional transform domain coefficients (or “side bins”) which are the result of the convolution operation increase the number of computations required for processing the coefficients. For this reason, the coefficient limiting unit (152 in FIG. 5) reduces the number of coefficients, if necessary, in order to increase the computational efficiency. In the illustration of FIG. 2, the number of coefficients is limited to a set S of five, thus discarding the other coefficients and reducing the number of parameters to be processed. It is noted that the number of additional coefficients generated also determines the time-frequency resolution of the synthesized signal.

The number of additional coefficients used depends advantageously on the original number of coefficients, and therefore on the number of sinusoidal components. To reduce the total number of coefficients, the number of additional coefficients used (contained in S in FIG. 2) is in a preferred embodiment inversely proportional to the number of original coefficients (P in FIG. 2). In a particularly preferred embodiment, the number of additional transform domain coefficients in a frame is equal to:
six if the original number of transform domain coefficients is smaller than three,
four if the original number of transform domain coefficients is between three and five,
two if the original number of transform domain coefficients is greater than four.

It will be understood that the actual number of additional transform domain coefficients used will depend on the particular embodiment. These numbers may apply per frequency band, preferably per ERB band or similar band.

A preferred embodiment of a transient synthesis (TS) unit 14 is illustrated in FIG. 4. The embodiment shown is provided with a transients discontinuation (TD) unit 141 which serves to discontinue transients of a previous frame if a transient of the present frame is synthesized. As further illustrated in FIG. 3, transients T1 and T2 may be synthesized in adjacent frames F1 and F2, first frame F1 starting at t=0 and second frame F2 starting at t=1.

The transient T1 of the first frame F1 will continue into the second frame F2, causing the synthesis of both T1 and T2 in at least part of the second frame F2. To prevent the synthesis of multiple transients, the first transient T1 is discontinued when the second frame F2 starts at t=1.

A further increase of the synthesis efficiency may be achieved when the sinusoidal synthesis (SS) unit 15 is provided with a coefficient limiting (CL) unit 152, as illustrated in FIG. 5. The coefficient limiting (CL) 152 limits the number of sinusoids synthesized in a frame, depending on the presence of a synthesized transient in the same frame, and optionally also on psycho-acoustic criteria. As a result, the number of sinusoidal coefficients Sc is reduced, thus reducing the number of computations required. The coefficient limiting unit 152 may be used in addition to, or instead of, the sinusoid selection unit 12.

The sinusoidal synthesis (SS) unit 15 is shown to further comprise a convolution (CON) unit 151 for convolving the transform domain coefficients represented by the selected sinusoidal parameters SP′ with the transform domain representation of a time window. The sinusoidal synthesis unit 15 may further comprise a coefficients generating unit (not shown) for generating the transform domain coefficients referred to above from the selected sinusoidal parameters SP′, and a storage unit (not shown) for storing the transform domain representation of the time window. The length of the time window is preferably chosen so as to allow an efficient transform and may have a length of, for example, 128, 256, 512 or 1024 coefficients, or 128×N, 256×N, etc. if oversampling is used, where N is the oversampling factor, which may for example be equal to 32.

A consumer device according to the present invention is schematically illustrated in FIG. 6. The consumer device 9 is shown to comprise a sound synthesis device 1 according to the present invention. In addition, the consumer device 9 may comprise additional elements, for example a sound data storage 2, an amplifier, loudspeaker, power source, control panel (not shown), etc. The consumer device 9 may be a portable audio player, a cellular (mobile) telephone apparatus, a portable digital assistant (PDA), a music synthesizer, a gaming device, or any other consumer device capable of outputting a digital or acoustical sound signal. The sound synthesis device 1 according to the present invention may also be used in sound systems, and is particularly suitable for use in parametric decoders and parametric synthesizers.

The present invention is based upon the insight that the efficiency of sound synthesis can be increased by selecting sound components to be synthesized, in particular when psycho-acoustic criteria are taken into account. The present invention benefits from the further insight that only a single transient per frame can be synthesized without substantially affecting the sound quality. The present invention benefits from the further insights that the number of sinusoids synthesized per frame may be reduced if a transient component is synthesized in the same frame, and that the number of additional coefficients produced by a transform domain convolution may be decreased while leaving the sound quality virtually unchanged.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents. Each of the embodiments may be used in isolation, or be combined with any of the other embodiments.

It will therefore be understood by those skilled in the art that the present invention is not limited to the embodiments illustrated above and that many modifications and additions may be made without departing from the scope of the invention as defined in the appending claims.

1. A device for producing sound samples from sound parameters representing sound components, the device comprising:
at least one selection unit for receiving frames containing sound parameters which represent sound components and for selecting, for each frame, a limited number of sound components, and
at least one synthesis unit for synthesizing any selected sound components from their parameters.

2. The device according to claim 1, comprising a transient selection unit for selecting, for each frame containing transient sound components, a single transient sound component, and a transient synthesis unit for synthesizing any selected transient sound components from their parameters.

3. The device according to claim 2, wherein the transient selection unit is provided with means for selecting the transient sound component having the largest energy content.

4. The device according to claim 2, wherein the transient synthesis unit is provided with a discontinuation unit for discontinuing a transient sound component of a previous frame when synthesizing a transient sound component in the present frame.

5. The device according to claim 1, comprising a sinusoidal selection unit for selecting, for each frame, one or more sinusoidal sound components, and a sinusoidal synthesis unit for synthesizing selected sinusoidal sound components from their parameters.

6. The device according to claim 2, wherein the sinusoidal selection unit reduces the number of selected sinusoidal components if the transient selection unit selects a transient component for the same frame.

7. The device according to claim 5, further comprising an inverse transform unit.

8. The device according to claim 5, wherein the sinusoidal selection unit comprise a convolution unit for convolving the transform domain coefficients with a transform domain representation of a time window, and wherein the sinusoidal selection unit is preferably also provided with a coefficient limiting unit for limiting the number of additional transform domain coefficients resulting from the convolution.

9. The device according to claim 8, wherein the coefficient limiting unit limits the number of additional transform domain coefficient in a frame in dependence on the original number of sound parameters in the frame, preferably per frequency band.

10. The device according to claim 1, comprising a noise selection unit for selecting, for each frame, noise sound components to be synthesized, and a noise synthesis unit for synthesizing noise sound components from their parameters.

11. A consumer device comprising a device according to claim 1.

12. A sound system comprising a device according to claim 1.

13. A method of producing sound samples from sound parameters representing transient sound components and other sound components, the method comprising the steps of:
receiving frames containing sound parameters which represent sound components,
selecting, for each frame, a limited number of sound components, and
synthesizing any selected sound components from their parameters.

14. The method according to claim 13, wherein the selecting step involves selecting, for each frame, a single transient sound component, and wherein the synthesizing step involves synthesizing any selected transient sound components from their parameters.

15. The method according to claim 14, wherein the selecting step involves selecting the transient sound component having the largest energy content.

16. The method according to claim 14, wherein the synthesizing step involves discontinuing a transient sound component of a previous frame when synthesizing a transient sound component in the present frame.

17. The method according to claim 13, further comprising the step of synthesizing sinusoidal sound components from sinusoidal sound parameters contained in a frame, and selecting sinusoidal sound components prior to the synthesis.

18. The method according to claim 14, further comprising the step of reducing the number of selected sinusoidal components if a transient sound component for the same frame is produced.

19. The method according to claim 13, wherein the sound parameters represent transform domain coefficients, the method preferably further comprising the step of inversely transforming said transform domain coefficients.

20. The method according to claim 19, further comprising the step of convolving the transform domain coefficients with a transform domain representation of a time window, and preferably limiting the number of additional transform domain coefficients resulting from the convolution.

21. The method according to claim 13, further comprising the steps of synthesizing noise sound components from noise sound parameters contained in a frame, and selecting noise sound components prior to the synthesis.

22. A computer program product for carrying out the method according to claim 13.
